(19) United States
(12) Patent Application Publication
(10) Pub. No.: US 2017/0260809 A1
(43) Pub. Date: Sep. 14, 2017

(54) STRETCHABLE LADDER

(71) Applicant: NEW-TEC INTEGRATION (XIAMEN) CO., LTD., Xiamen (CN)

(72) Inventor: Luhao LENG, Xiamen (CN)

(73) Assignee: NEW-TEC INTEGRATION (XIAMEN) CO., LTD., Xiamen (CN)

(21) Appl. No.: 15/458,518

(22) Filed: Mar. 14, 2017

(30) Foreign Application Priority Data
Mar. 14, 2016 (CN) 201620193825.4

(51) Int. Cl. E06C 1/18; E06C 1/38; E06C 7/08; E06C 7/42

(52) U.S. Cl. CPC E06C 1/18; E06C 7/423; E06C 1/38; E06C 7/08

(57) ABSTRACT

A stretchable ladder has two stretchable ladder racks, the top of the two stretchable ladder racks are pivoted together to a herringbone structure that can be open and closed, the stretchable ladder rack comprises an inner ladder rack and an outer ladder rack connecting together in stretching way, the inner ladder rack comprises two inner legs and an inner cross beam connecting the two inner legs, the outer ladder rack comprises two outer legs and an outer cross beam connecting the two outer legs, the inner leg is slidably connected to the outer leg, wherein the cross section of the inner leg and the outer leg is closed hollow tube shaped; two outer legs are respectively disposed at the outer side of the two inner legs, the inner cross beam of the inner ladder rack is disposed between the two outer legs of the outer ladder rack.

### FIELD OF THE INVENTION

The present invention relates to a ladder, particularly to a stretchable ladder.

### BACKGROUND OF THE INVENTION

Ladders are a tool that be used frequently for climbing operations in our life, such as the replacement of light bulbs, roof maintenance, interior decoration and so on. According to the function, ladders can be divided into stretchable ladders and non-stretchable; the stretchable ladder has the height adjustable, making it very convenient to use, and it is now being the first choice for consumers. The existing stretchable ladder comprises inner legs and outer legs two parts; the outer leg is a non-closed groove structure and half wrapping the inner leg, to achieve the ladder stretching. In actual use, when the ladder stretches, the inner legs and the outer legs separate apart so the strength of the outer leg is very weak, what is more, the bottom of the ladder is not strong enough ,that is a big security risk when used.

### SUMMARY OF THE INVENTION

The present invention is provided with a stretchable ladder with strong strength, which overcomes the disadvantages of the existing known technology. The technical proposal of the present invention is that:

A stretchable ladder, comprising two stretchable ladder racks, the top of the two stretchable ladder racks are pivoted together to a herringbone structure that can be open and closed, the stretchable ladder rack comprises an inner ladder rack and an outer ladder rack connecting together in stretching way, the inner ladder rack comprises two inner legs and an inner cross beam connecting the two inner legs, the outer ladder rack comprises two outer legs and an outer cross beam connecting the two outer legs, the inner leg is slidably connected to the outer leg, wherein the cross section of the inner leg and the outer leg is closed hollow tube shaped; two outer legs are respectively disposed at the outer side of the two inner legs, the inner cross beam of the inner ladder rack is disposed between the two outer legs of the outer ladder rack.

In another preferred embodiment, the inner cross beam is connected to the inner side surface of the inner leg, the outer cross beam is connected to a front end face of the outer leg faced to the user; the inner ladder rack is embedded to the outer ladder rack; the inner leg is a straight long tube, the outer leg is a straight long tube.

In another preferred embodiment, the outer side surface of the inner leg and the inner side surface of the outer leg form sliding surfaces faced to each other; the sliding surface of the inner leg is disposed with a hook lug, the sliding surface of the outer leg is disposed with a hook lug, the hook lug of the sliding surface of the inner leg is locked to the hook lug of the sliding surface of the outer leg.

In another preferred embodiment, the outer side surface of the inner leg and the inner side surface of the outer leg form sliding surfaces faced to each other; the sliding surface of the inner leg is disposed with a sliding groove, the sliding surface of the outer leg is disposed with a sliding rail, the sliding rail is slidably inserted to the sliding groove.

In another preferred embodiment, the outer side surface of the inner leg and the inner side surface of the outer leg form sliding surfaces faced to each other; the sliding surface of the outer leg is disposed with a sliding groove, the sliding surface of the inner leg is disposed with a sliding rail, the sliding rail is slidably inserted to the sliding groove.

In another preferred embodiment, the sliding groove is a dovetail groove.

In another preferred embodiment, the front end face of the inner leg is aligned with the front end face of the outer leg; the rear end face of the inner leg is aligned with the rear end face of the outer leg.

In another preferred embodiment, the outer side surface of the outer leg is curved and protruding outwardly.

In another preferred embodiment, the cross section of the inner leg is a right trapezoid or square; the cross section of the outer leg is a right trapezoid or square.

In another preferred embodiment, the outer ladder rack further comprises two support elements respectively connected to the bottom portion of the two outer legs and forming a horoscope structure.

Compared to the existing known technology, the technical solution of the present invention has following advantages:

1.The cross section of the inner leg and the outer leg is closed hollow tube structure, so the strength of the legs is well, they are not easily deformed, so they can bear more; based on the strength requirement, the ladder can use less material. The outer legs are disposed at the outer side of the inner legs, the inner cross beam of the inner ladder rack is disposed between the two outer leg of the outer ladder rack, the inner cross beam is aligned with the outer leg, the inner ladder rack is embedded in the outer ladder rack, the stretchable ladder rack is thin, the ladder has a thin thickness when it is folded.

2. The inner legs and the outer legs are straight long tubes, achieving a long structure and a stable structure.

3. Two support elements are respectively connected to the bottom portion of the two outer legs and forming a horoscope structure, they span large and stand stably on the ground, the stability of the ladder is improved.

### BRIEF DESCRIPTION OF THE DRAWINGS

The present invention will be further described with the drawings and embodiments.

FIG. 1 illustrates a schematic diagram of a stretchable ladder of the present invention.

FIG. 2 illustrates a schematic diagram of the ladder of FIG. 1 in stretching mode.

FIG. 3 illustrates a sectional diagram of a stretching ladder rack of the ladder of FIG. 1.

FIG. 4a illustrates a schematic diagram of the inner leg and a outer leg of the stretching ladder rack in a first connecting way.

FIG. 4b illustrates a schematic diagram of the inner leg and a outer leg of the stretching ladder rack in a second connecting way.

FIG. 4c illustrates a schematic diagram of the inner leg and a outer leg of the stretching ladder rack in a third connecting way.

FIG. 5a illustrates a schematic diagram of the inner leg and a outer leg of the stretching ladder rack in a fourth connecting way.

FIG. 5b illustrates a schematic diagram of the inner leg and a outer leg of the stretching ladder rack in a fifth connecting way.

FIG. 5c illustrates a schematic diagram of the inner leg and a outer leg of the stretching ladder rack in a sixth connecting way.

FIG. 6a illustrates a schematic diagram of the inner leg and a outer leg of the stretching ladder rack in a seventh connecting way.

FIG. 6b illustrates a schematic diagram of the inner leg and a outer leg of the stretching ladder rack in a eighth connecting way.

FIG. 6c illustrates a schematic diagram of the inner leg and a outer leg of the stretching ladder rack in a ninth connecting way.

FIG. 7 illustrates a schematic diagram of the support element and the outer leg of the stretchable ladder rack of FIG. 1.

### DETAILED DESCRIPTION OF THE EMBODIMENTS

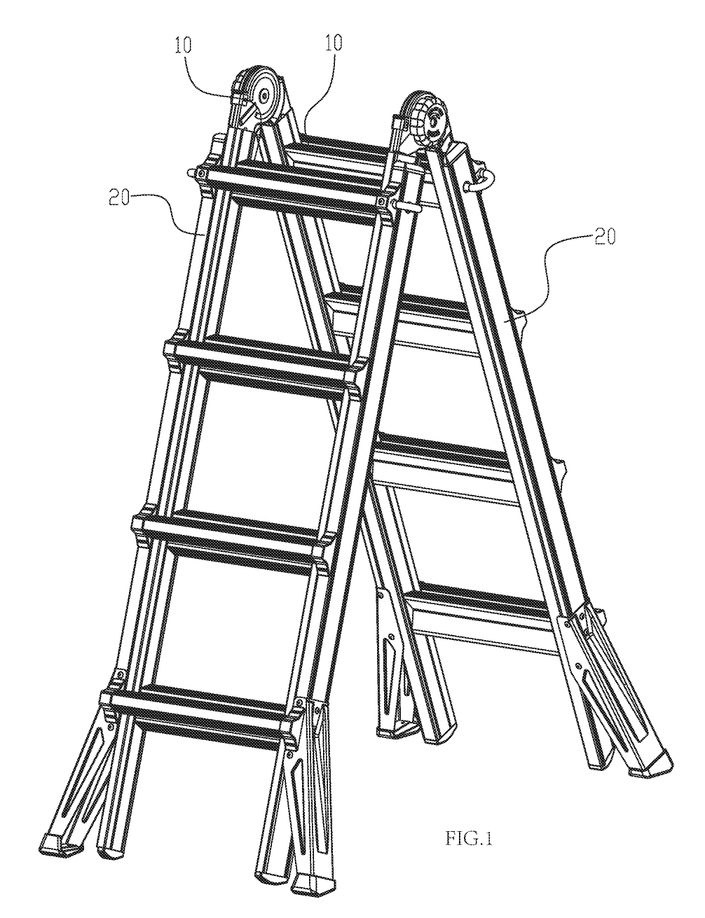

Referring to FIGS. 1-3, the stretchable ladder comprises two stretchable ladder racks, the top of the two stretchable ladder racks are pivoted together to a herringbone structure that can be open and closed, the stretchable ladder rack comprises an inner ladder rack 10 and an outer ladder rack 20 connecting together in stretching way, the inner ladder rack 10 comprises two inner legs 12 and a plurality of inner cross beams 14 connecting the two inner legs 12, the outer ladder rack 20 comprises two outer legs 22 and a plurality of outer cross beam 24 connecting the two outer legs 22. Two outer legs 22 are disposed at the outer side of the tow inner legs 12, the inner leg 12 is slidably connected to the outer leg 22. The inner cross beams 14 of the inner ladder rack and the outer legs 22 of the outer ladder rack are in a line, that is to say, the inner cross beams of the inner ladder rack are disposed between the two outer legs of the outer ladder rack, the inner cross beams are aligned with the outer legs. The cross section of the inner leg 12 and the outer leg 22 is closed hollow tube shaped. The front end face of the inner legs 12 is aligned with the front end face of the outer leg 22; the rear end face of the inner leg 12 is aligned with the rear end face of the outer leg 22.

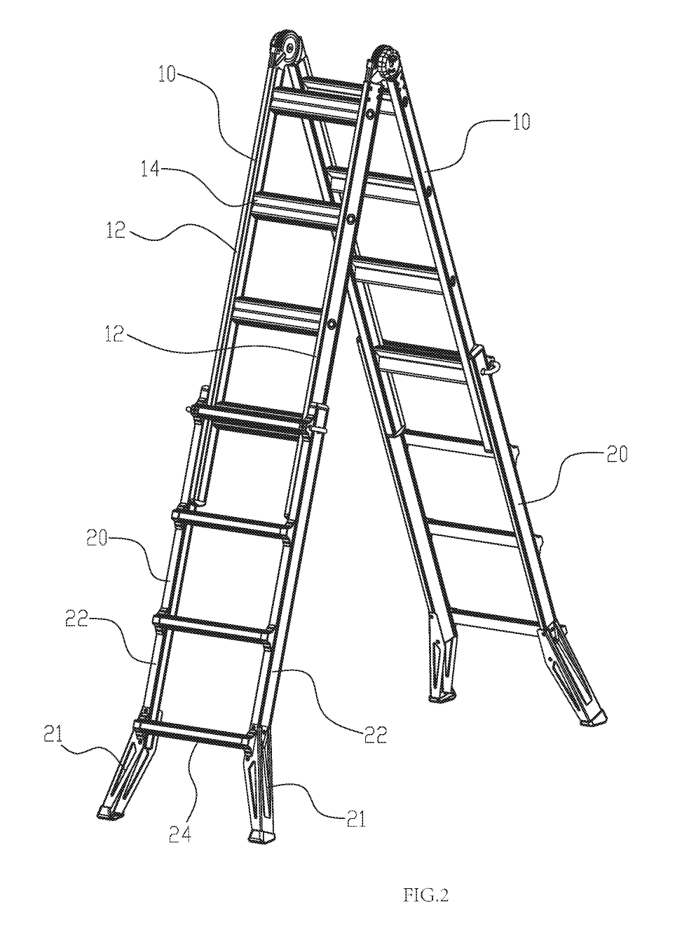

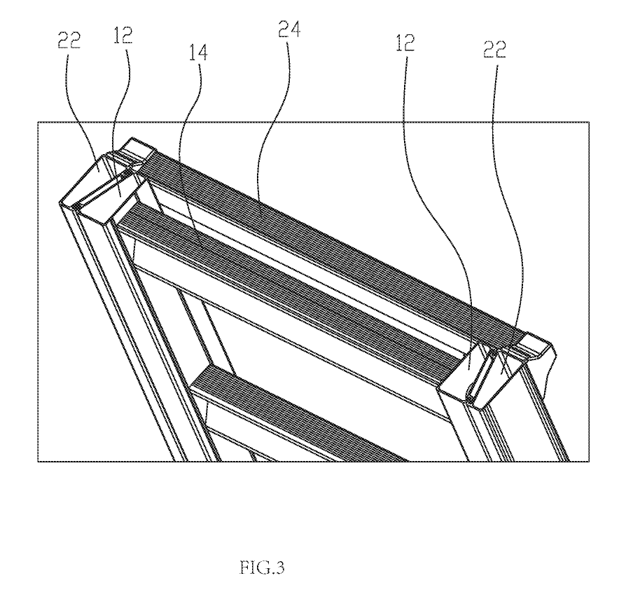

Referring to FIG. 2 and FIG. 3, the inner cross beams 14 are connected to the inner side of the inner leg 12, the outer cross beams 24 are connected to the front end face of the outer leg faced to the user, the inner ladder rack 10 is embedded to the outer ladder rack. The inner legs 12 and the outer legs are straight long tubes and are closed hollow tubes, the outer side of the inner leg 12 and the inner side of the outer leg 22 form sliding surfaces faced to each other.

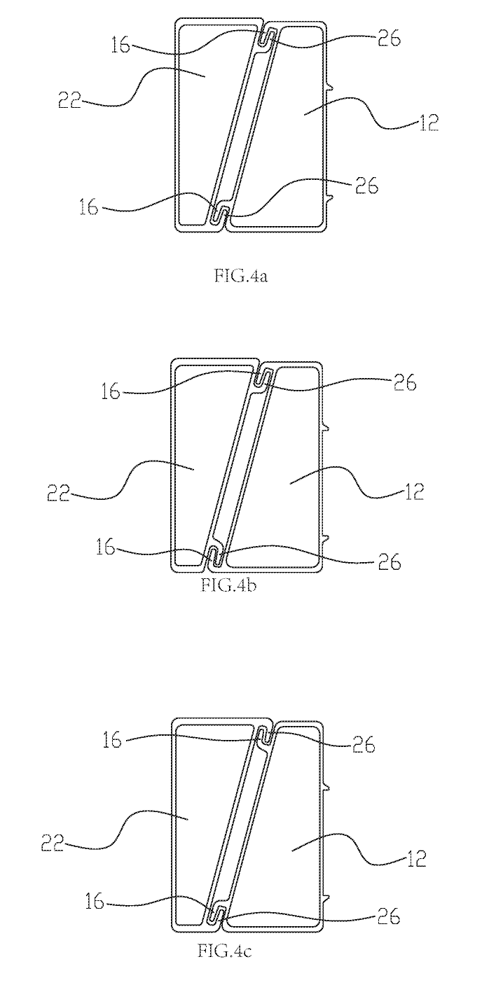

Referring to FIGS. 4a-4c, the sliding surface of the inner leg 12 is disposed with a hook lug 16, the sliding surface of the outer leg 22 is disposed with a hook lug 26, the hook lug 16 of the sliding surface of the inner leg is locked to the hook lug 26 of the sliding surface of the outer leg. The number and structure of the hook lug 16 and the hook lug 26 are not limited, only if the sliding surfaces can be locked.

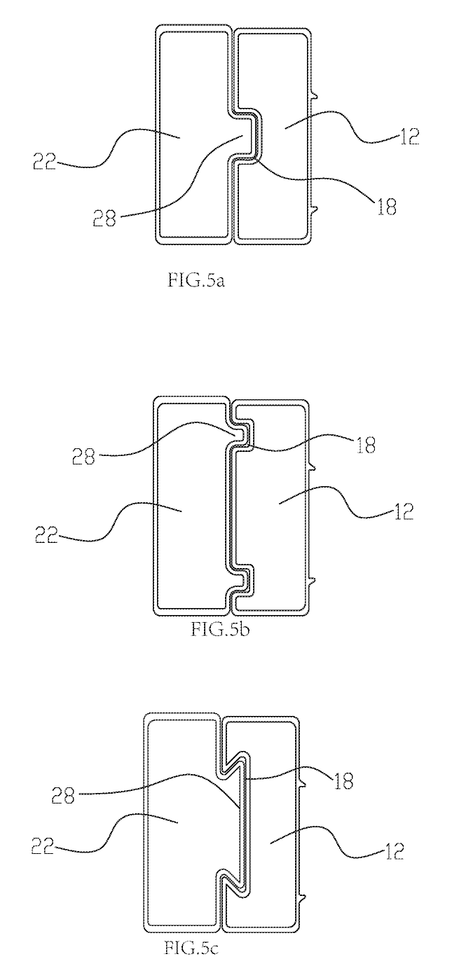

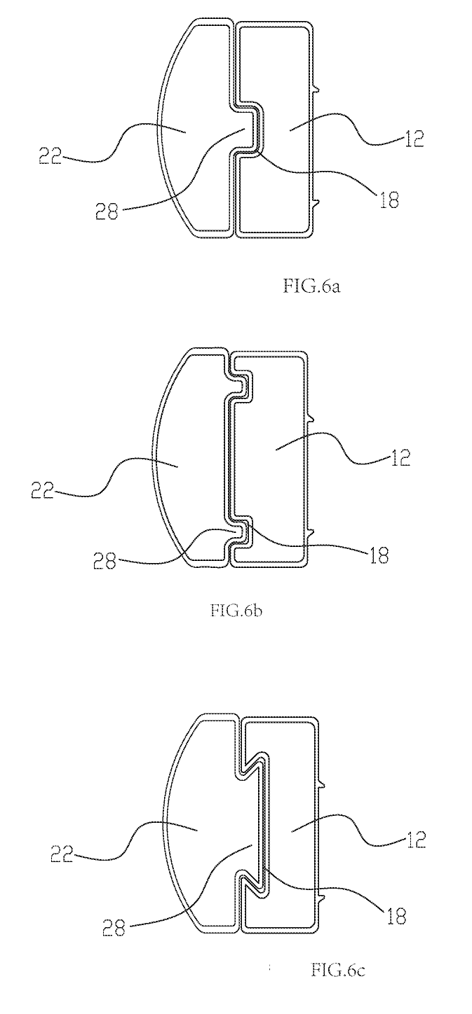

Referring to FIGS. 5a-6c, the sliding surface of the inner leg 12 is disposed with a sliding groove 18, the sliding surface of the outer leg 22 is disposed with a sliding rail 28, the sliding rail 28 is slidably inserted to the sliding groove 18, achieving the connecting of the inner leg 12 and outer leg 22 in slidably stretching way. Or in other cases, the sliding surface of the outer leg is disposed with a sliding groove, the sliding surface of the inner leg is disposed with a sliding rail, the sliding rail is slidably inserted to the sliding groove. The sliding groove 18 is preferred a dovetail groove.

Referring to FIGS. 4a-6c, the cross section of the inner leg 12 is a right trapezoid or square; the cross section of the outer leg 22 is a right trapezoid or square. Preferred, the outer side surface of the outer leg 22 is curved and protruding outwardly.

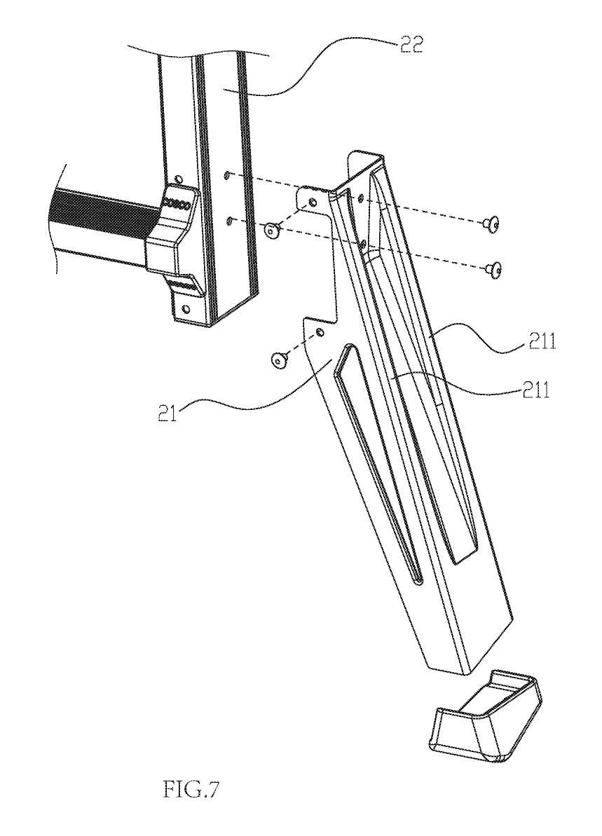

Referring to FIG. 2 and FIG. 7, the outer ladder rack 20 further comprises two support elements 21 respectively connected to the bottom portion of the two outer legs 22 at the outer side of the outer leg, the two support elements 21 form a horoscope structure standing on the ground. The support elements 21 are iron elements, the outer legs 22 and the inner legs are aluminum elements. The support element 21 is a housing structure with the inner side opening, the support element 21 is locked to the outer leg 22 by the opening, and the support element 21 is riveted to the outer leg 22 by rivets. Preferred, the outer side of the support element 21 is protruding with ribs 211.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A stretchable ladder, comprising two stretchable ladder racks, the top of the two stretchable ladder racks are pivoted together to a herringbone structure that can be open and closed, the stretchable ladder rack comprises an inner ladder rack and an outer ladder rack connecting together in stretching way, the inner ladder rack comprises two inner legs and an inner cross beam connecting the two inner legs, the outer ladder rack comprises two outer legs and an outer cross beam connecting the two outer legs, the inner leg is slidably connected to the outer leg, wherein the cross section of the inner leg and the outer leg is closed hollow tube shaped; two outer legs are respectively disposed at the outer side of the two inner legs, the inner cross beam of the inner ladder rack is disposed between the two outer legs of the outer ladder rack.

2. The stretchable ladder according to claim 1, wherein the inner cross beam is connected to the inner side surface of the inner leg, the outer cross beam is connected to a front end face of the outer leg faced to the user; the inner ladder rack is embedded to the outer ladder rack; the inner leg is a straight long tube, the outer leg is a straight long tube.

3. The stretchable ladder according to claim 2, wherein the outer side surface of the inner leg and the inner side surface of the outer leg form sliding surfaces faced to each other; the sliding surface of the inner leg is disposed with a hook lug, the sliding surface of the outer leg is disposed with a hook lug, the hook lug of the sliding surface of the inner leg is locked to the hook lug of the sliding surface of the outer leg.

4. The stretchable ladder according to claim 2, wherein the outer side surface of the inner leg and the inner side surface of the outer leg form sliding surfaces faced to each other; the sliding surface of the inner leg is disposed with a sliding groove, the sliding surface of the outer leg is disposed with a sliding rail, the sliding rail is slidably inserted to the sliding groove.

5. The stretchable ladder according to claim 2, wherein the outer side surface of the inner leg and the inner side surface of the outer leg form sliding surfaces faced to each other; the sliding surface of the outer leg is disposed with a sliding groove, the sliding surface of the inner leg is disposed with a sliding rail, the sliding rail is slidably inserted to the sliding groove.

6. The stretchable ladder according to claim 4, wherein the sliding groove is a dovetail groove.

7. The stretchable ladder according to claim 3, wherein the front end face of the inner leg is aligned with the front end face of the outer leg; the rear end face of the inner leg is aligned with the rear end face of the outer leg.

8. The stretchable ladder according to claim 7, wherein the outer side surface of the outer leg is curved and protruding outwardly.

9. The stretchable ladder according to claim 7, wherein the cross section of the inner leg is a right trapezoid or square; the cross section of the outer leg is a right trapezoid or square.

10. The stretchable ladder according to claim 1, wherein the outer ladder rack further comprises two support elements respectively connected to the bottom portion of the two outer legs and forming a horoscope structure.

11. The stretchable ladder according to claim 5, wherein the sliding groove is a dovetail groove.

12. The stretchable ladder according to claim 4, wherein the front end face of the inner leg is aligned with the front end face of the outer leg; the rear end face of the inner leg is aligned with the rear end face of the outer leg.

13. The stretchable ladder according to claim 5, wherein the front end face of the inner leg is aligned with the front end face of the outer leg; the rear end face of the inner leg is aligned with the rear end face of the outer leg.

14. The stretchable ladder according to claim 12, wherein the outer side surface of the outer leg is curved and protruding outwardly.

15. The stretchable ladder according to claim 13, wherein the outer side surface of the outer leg is curved and protruding outwardly.
